(19) United States
(12) Patent Application Publication
(10) Pub. No.: US 2010/0250837 A1
(43) Pub. Date: Sep. 30, 2010

(54) Method for Addressing Page-Oriented Non-Volatile Memories

(75) Inventors: Franz Schmidberger, Konstanz (DE); Christoph Baumhof, Radolfzell (DE)

Correspondence Address: LERNER GREENBERG STEMER LLP, P O BOX 2480, HOLLYWOOD, FL, 33022-2480, US

(73) Assignee: Hyperstone GmbH, Konstanz (DE)

(21) Appl. No.: 12/742,033

(22) PCT Filed: May 28, 2008
(86) PCT No.: PCT/EP2008/056524

§ 371 Date: May 7, 2010

(51) Int. Cl. G06F 12/02; G06F 12/00

(52) U.S. Cl. 711/103; 711/E12.001; 711/E12.008

(57) ABSTRACT

A method for addressing memory pages of a non-volatile memory in a memory system with a memory controller and a further volatile memory. The non-volatile memory is organized in erasable memory blocks with a multiplicity of memory pages, and each memory page, containing a number of sectors, can be written individually. The volatile memory holds an address translation table specifying an assignment of logical memory page addresses to physical memory page addresses. By way of the memory controller, a reconstruction table is stored as a copy of the address translation table in one or more memory blocks in the non-volatile memory, a log book table with data records containing changed assignments of logical memory page addresses to physical memory page addresses, is carried in the volatile memory and, if the log book table exceeds a predetermined size, a changed reconstruction table is stored in the non-volatile memory.

The invention relates to a method for addressing memory pages of a non-volatile memory in a memory system with a memory controller and a further volatile memory, wherein the non-volatile memory is organized in erasable memory blocks with a multiplicity of memory pages, and each memory page, containing a number of sectors, can be written individually, and wherein the volatile memory holds an address allocation table specifying an assignment of logical memory page addresses to physical memory page addresses.

Since the introduction of Solid State Disks (SSD), big memory systems can be based on flash memory and be operated in the same way as conventional magnetic memory systems. The data records in the memory system are addressed as logical sectors that can be read, written and erased as it is necessary. Flash memory has the restriction that only erased memory cells can be written to and that large blocks, containing many sectors, have to be erased at a time. If one sector within a block is changed, according to the conventional method, it is written to an erased sector in an alternate block. In case this sector has to be changed once again, it has to be written to yet another alternate block and all other unchanged sectors have to be copied to the new alternate block. Since each memory block can contain many sectors—currently blocks have a size of 256 kByte—the process of copying unchanged sectors is rather time-consuming and slows down the memory system.

There have been several suggestions to mitigate this problem. Patent DE 103 49 595, for example, describes how sectors that are frequently changed can be written to the same alternate block sequentially. This requires an additional table, which indicates the position of the current sector and which has to be consulted for each memory operation. This method is only a minor improvement to the speed of the memory system.

Modern flash memories are page-oriented. Four or eight sectors form one memory page and are written to an erased part of the memory block. The aforementioned procedure concerning the alternate blocks could also be applied to memory pages instead of sectors, but its disadvantages would remain.

It is the object of the invention to present a method for writing to page-oriented memories, in which the speed of the memory system is significantly higher than that of previous methods.

This object is met by the features of claim 1.

Claim 7 describes the implementation of the method in a memory system.

The dependent claims describe advantageous embodiments of the invention.

In order to implement the method, a large address allocation table is kept in the volatile memory of a memory system, which contains the current allocations of logical memory page addresses and physical memory page addresses. This table is also written to the non-volatile memory as a reconstruction table.

Every time a memory page is rewritten, an entry is made in the address allocation table, assigning an erased memory page to its logical memory address, and the modified content of this memory page is written to the assigned page. At the same time, this new allocation of the page address is noted in a log book.

In case of a power failure, the log book is saved in the non-volatile memory.

When the memory system is restarted after an intentional or unintentional power failure, the address allocation table is reconstructed in the volatile memory, on the basis of the reconstruction table and the log book.

The details of the method and of the memory system are illustrated by the figures.

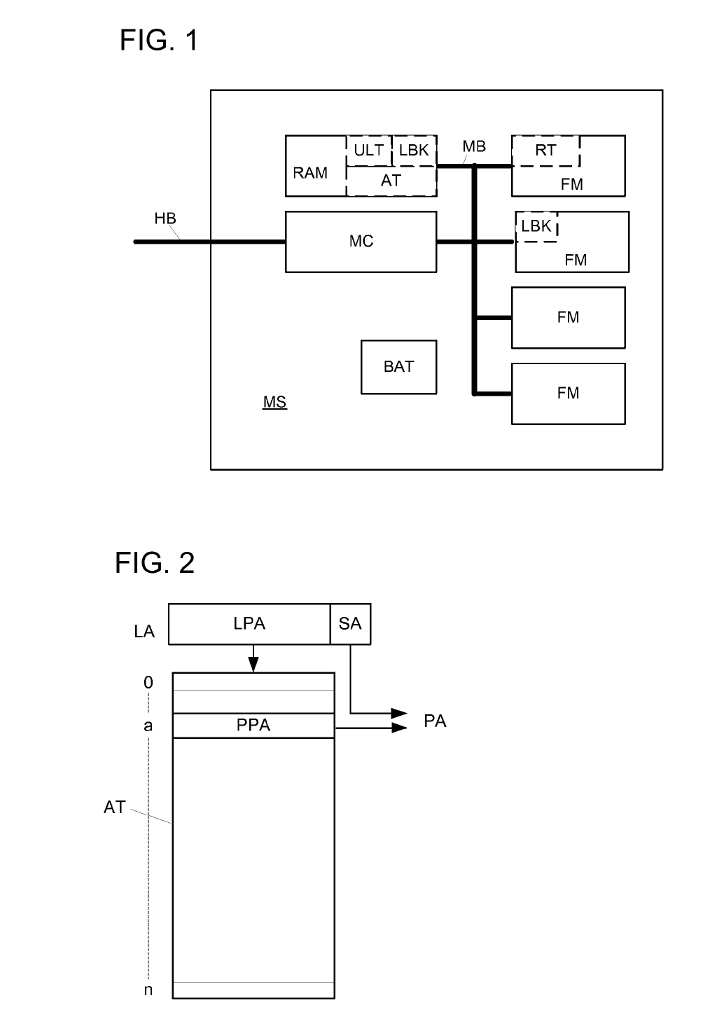

FIG. 1 shows a typical memory system.

FIG. 2 illustrates the structure of the address allocation table in the RAM.

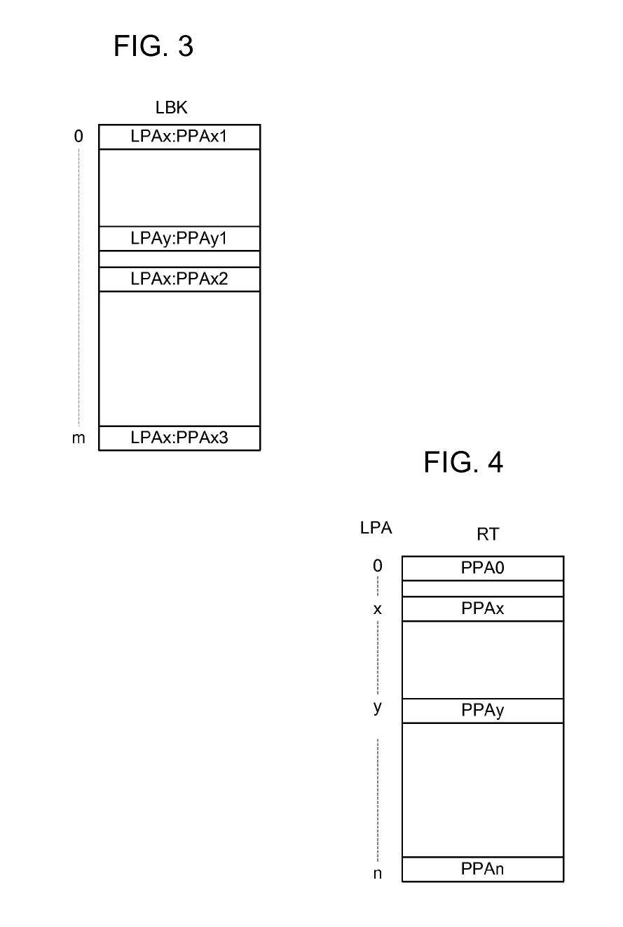

FIG. 3 illustrates the structure of the log book in the RAM.

FIG. 4 illustrates the structure of the reconstruction table in the flash memory.

FIG. 1 is the representation of a memory system MS, which is connected to a computer system via a host bus HB. The host bus can be one of various types, such as a Universal Serial Bus USB or a SATA bus. The memory commands with the corresponding logical addresses are transmitted to the memory system via the host bus HB.

The data records of the memory system are stored in the non-volatile memory, which in this case is a flash memory FM with several chips.

A memory controller MC in the memory system evaluates and executes the memory commands. For this purpose, the address allocation table AT is kept in the volatile memory RAM, assigning logical addresses to physical addresses, which are needed to access the flash memory FM.

The reconstruction table RT is stored in a non-volatile flash memory chip. New address allocations of logical and physical page addresses are recorded in the log book LBK in the RAM. Likewise, the utilisation of the logbook is noted in the utilisation table ULT.

In case of a power failure, the log book LBK is stored in the flash memory FM. A battery BAT ensures that the energy needed for the backup operation is provided. The battery BAT can also be an accumulator or a capacitor.

As FIG. 2 shows, the address allocation table AT contains the corresponding physical memory page addresses PPA for all logical addresses LA. The logical address LA is divided into a logical memory page address LPA and a sector address SA. The logical memory page address LPA serves as an index from 0 to n for the table. The physical address PA that is used in memory commands such as reading or writing is composed of the current physical memory page address PPA, here with the index A, and the sector address SA. If a new physical memory page address is required for writing a memory page, the entry in the address allocation table is changed.

This change is also recorded in the log book LBK, the basic structure of which is illustrated in FIG. 3. It contains entries for the address allocations that have been made, assigning the respectively changed physical memory page addresses—in this case PPAx1 to PPAx3 and PPAyI—to the logical memory page addresses—in this case LPAx and LPAy.

The reconstruction table RT is kept in a non-volatile memory FM. Its structure is represented in FIG. 4. The table contains a copy of the address allocation table as it was last saved. The index in the table is the logical memory page address LPA and the entries indicate corresponding physical memory page addresses PPA. These allocations are not completely up to date, because the address allocation table has been changed since the last time it was saved.

If the address allocation table AT is reconstructed after an intentional or unintentional power failure, a current version is generated from the reconstruction table and the saved log book. The outdated entries—in this example PPAx and PPAy—are replaced with the current allocations from the log book, in such a way that the log book is read sequentially and the respective entries in the address allocation table AT are rewritten. Entries can be replaced several times—as in this case PPAx. When the log book has been completely read, the address allocation table AT is up to date. The log book list can either be organized as a linear list or as a linked list.

The log book has a defined maximum length. If this length is reached, the current address allocation table AT is saved as a reconstruction table RT in the non-volatile memory. Since the reconstruction table RT can be very long and thus can take up several memory blocks, only the memory block of the reconstruction table RT is changed, the entries of which have been rewritten most often. For this purpose a utilisation table ULT is kept in the volatile memory, which counts the number of changes per memory block. Now this utilisation table ULT is searched for the memory block of the reconstruction table RT that has been changed most often. This memory block is rewritten with the current address allocations and concatenated in the reconstruction table RT. Then the entries in the log book LBK and in the utilisation table ULT referring to this updated memory block of the reconstruction table RT are erased. This shortens the log book so that current changes can again be written. The memory block of the reconstruction table RT that has been replaced is now released for erasing.

With the aforementioned steps, memory operations in large flash memory systems, in solid state disks in particular, can be performed much faster than with conventional methods. Wasteful copying of unchanged sectors from one a memory block to another is reduced to a minimum, which means that only the sectors of one memory page are copied.

### REFRENCES

AT address allocation table

BAT battery

FM flash memory

HB host bus

LA logical address

LBK log book

LPA logical memory page address

MB memory bus

MC memory controller

MS memory system

PA physical address

PPA physical memory page address

RAM random access memory

RT reconstruction table

SA sector address

SSD solid state disk

ULT log book utilisation table

1-11. (canceled)

12. A method of addressing memory pages of a non-volatile memory in a memory system with a memory controller and a volatile memory, wherein the non-volatile memory is organized in erasable memory blocks with a multiplicity of memory pages, and each memory page, containing a number of sectors, can be written individually, and wherein the volatile memory holds an address allocation table specifying an assignment of logical memory page addresses to physical memory page addresses, the method which comprises the following steps, to be carried out by the memory controller:
storing a reconstruction table as a copy of the address allocation table in one or more memory blocks in the non-volatile memory;
carrying in the volatile memory a log book with data records containing changed assignments of logical memory page addresses to physical memory page addresses; and
if the log book exceeds a predetermined size, storing a changed reconstruction table in the non-volatile memory; and
subsequently erasing data records describing address allocations that are no longer up to date from the log book.

13. The method according to claim 12, which comprises, in case of a power failure of the memory system, transferring the log book to the non-volatile memory.

14. The method according to claim 13, which comprises, upon restarting the memory system after a power failure, transferring the reconstruction table to the volatile memory and forming a current address allocation table on the basis of the saved log book.

15. The method according to claim 12, which comprises organizing the address allocation table and the reconstruction table in the order of the logical memory page addresses.

16. The method according to claim 15, wherein a utilization table contains a counter counting the changes for each of the memory blocks in which the reconstruction table is stored, and wherein, if the size of the log book is exceeded, the memory block of the reconstruction table, the address allocations of which have been changed most often, is rewritten with the current address allocations.

17. The method according to claim 12, which comprises releasing for erasure those memory blocks that contain parts of the reconstruction table that are no longer valid.

18. A memory system, comprising: a non-volatile memory, a memory controller, and a volatile memory, configured to carry out the method according to claim 12.

19. The memory system according to claim 18, wherein said non-volatile memory is a flash memory.

20. The memory system according to claim 19, wherein a memory page contains four or eight sectors, and a memory block contains 64 or 128 pages.

21. The memory system according to claim 18, which further comprises an energy storage device having a capacity sufficient to guarantee a writing process of the log book to the non-volatile memory in case of a power failure.

22. The memory system according to claim 21, wherein said energy storage device is a battery, an accumulator, or a capacitor.
